(19) United States
(12) Patent Application Publication
(10) Pub. No.: US 2007/0192043 A1
(43) Pub. Date: Aug. 16, 2007

(54) Method for providing a high-resolution angle mark signal

(76) Inventors: Josef Moik, Graz (AT); Thomas Semanek, Judendorf (AT); Franz Summerauer, Deutsch-Feistritz (AT)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 11/641,103

(22) Filed: Dec. 19, 2006

(30) Foreign Application Priority Data
Dec. 29, 2005 (AT) GM 900/2005

(51) Int. Cl. G01B 5/28; G06F 19/00

(52) U.S. Cl. 702/38; 701/114

(57) ABSTRACT

A method for providing a high-resolution angle mark signal comprises the detection of a low-resolution angle mark signal and of a revolution trigger. Based on the low-resolution angle marks, angle marks are generated, subsequently, of a frequency that is increased by a multiplication factor, which can be preset. In order to achieve a precise multiplication of the crank angle signal even at highly dynamic speed changes, whereby with a high level of probability only a negligible deviation exists between the generated output marks and their theoretically correct positions, the high-resolution output angle marks generated since the occurrence of the revolution trigger are counted continually, and this counted value is compared, respectively, upon the incoming of a new input angle mark to the value that is calculated by counting the input angle marks since occurrence of the revolution trigger and multiplication by a multiplication factor, and the frequency of the output angle marks is corrected as of the new input angle mark as a function of this deviation.

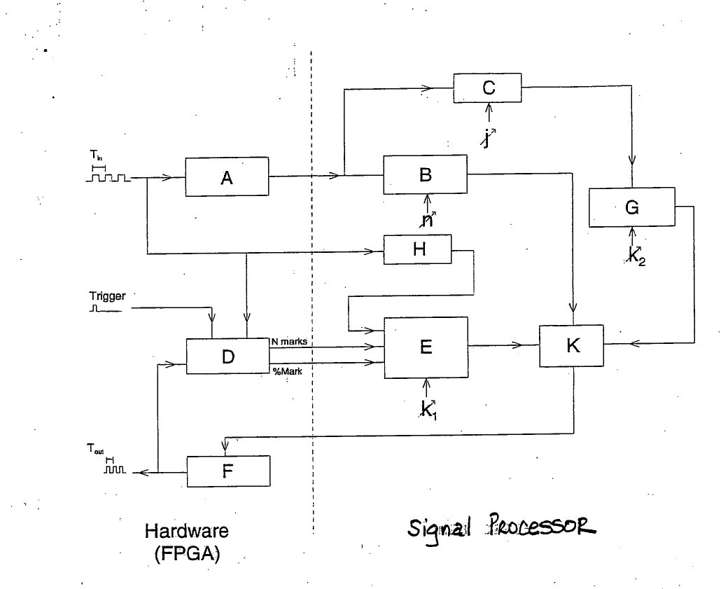

### BACKGROUND OF THE INVENTION

1. Field of the Invention

The invention relates to a method for providing a high-resolution angle mark signal, and whereby a low-resolution angle mark signal can also be detected as a revolution trigger, and whereby the latter can also be synthesized from a gap in the low-resolution angle mark signal, and whereby, based on the low-resolution angle marks, angle marks are generated of a frequency that is increased by a multiplication factor that can be preset, as well as an apparatus for implementing the method, including an input for the low-resolution angle mark signal and a revolution trigger signal, a module for the high-resolution measuring of the incoming angle mark signals, a mark generator module for generating frequency-multiplied angle marks and a calculation module for controlling the mark generator module.

2. The Prior Art

Indicated systems have increasingly come in use for purposes of tuning and developing engine control devices in motor vehicles. These measuring systems detect values such as cylinder pressure in a way that is crank angle synchronous and conduct characteristic value calculations in real time. In order for this to occur, however, a high-resolution crank angle signal is required as scanning basis. But optical precision angular rotation sensors are difficult to mount inside the vehicle. This is why, frequently, one has to make due with coded plates of course resolution (e.g. 60-2 teeth) or ring gears. These angle signals must now be multiplied via suitable steps in order to arrive as precisely as possible at the desired angular resolution (e.g. 0.1 degree). If coded plates (60-2) are used, a revolution trigger signal (OT signal), in addition, must be derived from the gap. In ring gear sensing elements an additional measured value sensor is required for the OT signal (e.g. camshaft sensor).

Implementations of the present object that are known in the art to date, e.g. conventional crank angle calculators, arrive at a solution by measuring the periodic time length of the input marks with a high-frequency time basis (e.g. 20 MHz), determination of the desired frequency that reflects the multiplication and adjustment to a digital pulse generator. Known implementations indeed take into account the fact that with coded plates, due to one or several missing teeth, a periodic time length of twice or multiple times will result intermittently, which may not be allowed to lead to a faulty shifting of the output frequency.

Since it is always the periodic time length of the previous input mark that is used for adjusting the current output mark frequency, and therefore the periodic time length of the output marks that have just been generated, deviations result at high multiplication levels and strong speed dynamics that may continue to accumulate within a revolution. But indicating systems continually monitor the number of angle marks between two revolution triggers. If the mark number does not correspond to the expected value, synchronization errors are reported, and it is impossible to conduct correct indicating measurements.

Therefore, the object of the present invention consisted in providing a method and/or an apparatus that will allow for arriving at a precise multiplication of the crank angle signal even at highly dynamic speed changes resulting with a high level of probability only in negligible deviations between the generated output marks and their theoretically correct positions.

### SUMMARY OF THE INVENTION

To arrive at this object the method as described in the introduction is characterized by the fact that the high-resolution output angle marks, which are generated starting with the occurrence of the revolution trigger, are continually counted, and wherein this counted value is compared, respectively upon arrival of a new input angle mark, to the calculated value that is established by counting the input angle marks since the occurrence of the revolution trigger and multiplication by the multiplication factor, and wherein the frequency of the output angle mark is corrected starting with the new input angle mark as a function of this deviation. This way, a correction is possible that will allow even in the presence of highly dynamic speed changes a precise mark multiplication across the entire revolution because deviations are compensated immediately, whereby any accumulation of errors is avoided.

An advantageous embodied example of the invention provides that, in addition to the number of the high-resolution output angle marks that are generated starting with the occurrence of the revolution trigger, the expired percentage part of the periodic time length of the currently applied output angle mark is established at the time of the incoming of a new input angle mark, that the frequency of the output angle marks continues to be implemented as a function of this refined deviation value starting as of the new input angle mark. This makes it possible to indicate the deviation between the actual value of the generated high-resolution angle marks and their desired value at the time of the incoming of the input mark not only as whole-numbered values but also as fractional values. This principle also allows for a precise multiplication of angle marks by a factor that is not a whole number, for example, as required when picking off marks off a rim of a flywheel—an instance in which the tooth number is often a prime number. But also with regard to whole-number multiplication factors, this way it is possible to arrive at an even more precise mark multiplication, also for highly dynamic speed changes. Moreover, any possible “pumping” of the digital control loop is also avoided in this manner.

According to another characteristic of the present invention the method is furthermore characterized by the fact that, in addition, the periodic time lengths of a number of input angle marks that can be preset are stored, and wherein the periodic time length of the next input angle mark is extrapolated on the basis of the stored values, and wherein the frequency of the output angle marks is corrected as a function of the deviation between the values of the periodic time length of the last detected input angle mark and the extrapolated value of the periodic time length. This allows for the advance calculation of the change of the instantaneous speed, and whereby this way the periodic time length of the next input mark is virtually predicted thereby allowing, by way of a precautionary measure, for the compensation of deviations of the generated angle marks that would not become visible until after the next input mark. This is important especially for quick changes of the instantaneous speed that result, for example, due to strong rotational vibrations or due to highly transient processes—such as at start-up of the engine.

To arrive at the fastest possible calculation of the correction value with the least possible effort, it is envisioned that the periodic time length be linearly extrapolated.

For purposes of obtaining a very precise extrapolation, the length of the periodic time may be extrapolated by polynomial approximation.

A further embodied example of the method according to the invention provides that the correction values for the output angle marks are linked with factors that can be preset. This allows for controlling the response dynamics of the correction process; and it can thus be adjusted to the precision of the used gear plates as well as to the magnitude of the multiplication.

Advantageously, in this context, the factors are adjusted as proportionate relative to the multiplication factor for the frequency of the output angle marks.

A further embodied example of the method according to the invention provides that the adjustment of the frequency of the output angle marks is effected asynchronously relative to the generated output angle marks. This way, one does not wait for the currently generated output mark to complete and only the next mark is generated using the newly calculated periodic time length, but instead, moreover, the periodic time length of the currently applied output mark is also still directly being influenced. This will allow to further increase the reaction time and thereby the accuracy of the multiplication circuit.

In order to arrive at the object of the invention the apparatus that is described in the introduction for implementing the method is characterized by having a counter module for the output angle marks that have been generated by the mark generator module since the occurrence of the revolution trigger signal, by having a counter module for the detected input marks and by having a comparison module which compares the number of the high-resolution output angle marks that have been generated since the occurrence of the revolution trigger, respectively, upon the incoming of a new input angle mark with the calculated value that was arrived at by counting the input angle marks since the occurrence of the revolution trigger and multiplication with a multiplication factor, and wherein said comparison module determines a correction value, and by having a correction module for correcting the adjustment values of the mark generator module as a function of the correction value of the comparison module. Correspondingly, in contrast to conventional devices, a more precise mark multiplication is possible that will take place even during highly dynamic speed changes and across the entire revolution, and whereby deviations are compensated immediately thus preventing any accumulation of errors.

An advantageous embodied example according to the invention provides that, in addition, the percentage of the expired part of the periodic time length of the current output mark is established inside the counter module at the time of the incoming of the input mark, and this value is also fed into the comparison module, whereby it is possible to indicate the deviation between the actual value of the generated angle mark and its desired value also in fractional parts. This makes it possible to arrive at a precise multiplication of angle marks by a factor that is not a whole number; and/or for multiplication factors that are whole numbers, it is possible to arrive at an even more precise mark multiplication even at highly dynamic speed changes. A modification of the frequency can be direct, i.e. it may directly impact the periodic time length of the mark that has just been generated, and whereby it is not necessary to await the end of said mark.

A further characteristic of the invention provides for a buffer module, which is to serve as an intermediate storage for the periodic time lengths of a number of input marks that can be preset, as well as an extrapolation module that is used to extrapolate on the basis of the former a period length that is to be expected for the next input mark, and whereby the adjustment value for the mark generator module is corrected in the correction module as a function of the difference between the extrapolated periodic time lengths and the actual periodic time length of the last mark. Advance calculation of the modification of the instantaneous speed in such a manner will allow to virtually predict the periodic time length of the next input mark, thereby allowing for taking precautionary compensatory steps relative to the deviations of the generated angle marks, deviations that would otherwise not become visible until after the next input mark.

A further advantageous example according to the invention provides that query routines are implemented at least in the comparison module and in the extrapolation module thus allowing for the input of values that are linked to the values which are fed into the correction module, whereby the dynamic of the readjustment behavior of the multiplication circuit can be optimized.

A further advantageous embodied example according to the invention provides that the counter module as well as the module for the high-resolution measuring of the incoming angle mark signals and the mark generator module for the generation of the frequency-multiplied angle marks are engineered as parts of a circuit in a freely programmable Gate Array (FPGA).

Advantageously, it is furthermore envisioned that the calculation module for controlling the mark generator module, the counter module for the detected input marks, the comparison module, the correction module, the buffer module and the extrapolation module are engineered as software modules in a signal processor.

### BRIEF DESCRIPTION OF THE FIGURE

In the subsequent description, the invention shall be illustrated in more detail using an embodiment and in reference to the enclosed drawing that represents by way of a schematic depiction the principle of the method.

### DETAILED DESCRIPTION OF THE PREFERRED EMBODIMENT

In the exemplary embodiment shown in the FIGURE, certain functional modules are implemented as hardware circuit in an FPGA while others are implemented as software modules of a signal processor. It is possible, correspondingly, to achieve high performance as well as high flexibility at the same time.

Circuit A measures at high resolution (e.g. 50 MHz) the periodic time length (Tin) of the input marks (Signal A) and triggers simultaneously with each mark an interrupt at a signal processor. The processor reads the current periodic time length into program part B and calculates based on this the output mark frequency that is increased by the desired multiplication (n), which is generated by circuit (F). In this context, missing teeth, as they occur with coded plates (60-2), are also detected and the measured periodic time length of such an extended input mark is calculated backwards for the length of a normal mark.

Circuit (F) is implemented here as counter that counts upward, also at high resolution (e.g. 50 MHz), until its value corresponds to a comparison value that can be preloaded. Subsequently an output mark (Signal B) is generated, the counter is set back and released once again to count upward. Correspondingly, this means that the periodic time length of the generated marks is directly proportionate relative to the currently preloaded comparison value. The comparison value can also be modified during the counting process, wherefore the new value that is determined by the signal processor can be adjusted directly and also impacts the length of the current mark—the end of which is in fact marked by the reaching of the comparison value.

If the speed changes, i.e., the periodic time length of the input marks, the output frequency will automatically follow suit correspondingly—but, by the nature of the matter, this always takes place at a delay by one input mark. Viewed across the total revolution, in particular in the presence of stronger speed changes, resulting are not only ongoing deviations of the output marks from their theoretically correct temporal positions but also cumulative errors, i.e. the number of generated marks per revolution does not match the theoretical desired value.

This is the reason why in circuit part (D) the number of generated marks is counted continually since the last revolution trigger (Nmarks). This value in program part (E) of the signal processor is compared to the theoretical desired value that is established in program part (H) by counting the input marks (=interrupts) and multiplication by a multiplication factor. The preloaded value of circuit (F) is adjusted by this established deviation in the program part. This would have achieved a compensation for the occurred deviation after the next input mark—provided there were no further speed-related changes. To improve accuracy the invention provides that the percentage of the expired part of the periodic time length of the current output mark is measured in a high-frequency manner in circuit (D) as well; and this value (% value) is also fed into program part (E) for the refined determination of the desired actual deviation.

In program part (C) the time lengths of the [respectively] last input marks are stored in a relocation buffer. With each incoming new mark the respectively oldest value is cleared. Using these values it is possible to conduct an extrapolation in program part (G). In the easiest case scenario this is a linear extrapolation, with a gradient being formed from the first and last values. But depending of the computing performance of the signal processor, it is also possible to execute a polynomious approximation, whereby this polynom can then be used for the extrapolation. The result is an expected periodic time length for the next input mark. The difference between this extrapolated length and the actual length of the last input mark is also utilized in program part (K) as correction value for the adjustment of the preloaded value of circuit (F).

The blocks (A), (D) and (F) are herein implemented as freely programmable digital components (FPGA); the blocks (C), (B), (E), (G) (H) and (K) are implemented as software modules of a signal processing program.

Since a deviation between actual and desired values is the consequence of a speed change which, in turn, becomes visible in the context of the speed extrapolation as well, the determined correction values are not directly added to the preloaded value of circuit (F) that is established in program part (B) due to the multiplication, but they are assigned a factor (k1 and k2), respectively. This way, it is possible to influence the control action from the outside. If the multiplication number is small, the factors should be selected as smaller as well. A factor of 0.5, respectively for k1 and k2, is recommendable for a typical multiplication of 6 degree input marks vs. 0.1 degree output marks.

We claim:

1. Method for providing a high-resolution angle mark signal, and whereby a low-resolution angle mark signal as well as a revolution trigger are detected, and whereby the latter can also be synthesized from a gap in the low-resolution angle mark signal, and whereby, based on the low-resolution angle marks, angle marks are generated of a frequency that is increased by a multiplication factor that can be preset wherein the high-resolution output angle marks that are generated since occurrence of the revolution trigger are continually counted, and wherein this counted value is compared, respectively at the time of the incoming of a new input angle mark, to the value that is calculated by the counting of the input angle marks starting as of the occurrence of the revolution trigger and multiplication by a multiplication factor, and wherein the frequency of the output angle marks is corrected as of the new input angle mark as a function of this deviation.

2. Method as claimed in claim 1, wherein, in addition to the number of the high-resolution output angle marks generated since the occurrence of the revolution trigger, the percentage of the expired part of the periodic time length of the currently applied output angle mark is established at the time of the incoming of a new input angle mark, and wherein the frequency of the output angle marks continues to be implemented as of the new input angle mark as a function of this refined deviation value.

3. Method as claimed in claim 1, wherein, in addition, the periodic time lengths of a number of input angle marks that can be preset are stored, and wherein the periodic time length of the next input angle mark is extrapolated based on the stored values, and wherein the frequency of the output angle marks is corrected as a function of the deviation between the value of the periodic time length of the last detected input angle mark and the extrapolated value of the periodic time length.

4. Method as claimed in claim 3, wherein the periodic time length is linearly extrapolated.

5. Method as claimed in claim 3, wherein the periodic time length is extrapolated by polynomious approximation.

6. Method as claimed in claim 1, wherein the correction values for the output angle marks are linked to factors that can be preset.

7. Method as claimed in claim 6, wherein the factors are set proportionately relative to the multiplication factor for the frequency of the output angle marks.

8. Method as claimed in claim 1, wherein the adjustment of the frequency of the output angle marks occurs asynchronously relative to the generated output angle marks.

9. Apparatus for implementing the method as claimed in claim 1, including an input for a low-resolution angle mark signal and a revolution trigger signal, a module (A) for the high-resolution measuring of the incoming angle mark signals, a mark generator module (F) for the generation of frequency-multiplied angle marks, and a calculation module (B) for controlling mark generator module (F) characterized by a counter module (D) for the output angle marks generated since the occurrence of the revolution trigger signal by mark generator module (F), a counter module (H) for the detected input marks and a comparison module (E), in which the number of the high-resolution output angle marks generated since the occurrence of the revolution trigger is compared at the time of the incoming of a new input angle mark with the value that was calculated by counting the input angle marks since the occurrence of the revolution trigger and multiplication by the multiplication factor, and wherein said comparison module (E) establishes a correction value, and having a correction module (K) for the correction of the adjustment values of mark generator module (F) as a function of the correction value of comparison module (E).

10. Apparatus as claimed in claim 9, wherein, in addition, the percentage of the expired part of the periodic time length of the current output mark is determined in counter module (D) at the time of the incoming of an input mark, and wherein this value (% mark) is also fed to comparison module (E).

11. Apparatus as claimed in claim 9, wherein a buffer module (C) is provided for the intermediate storage of the periodic time lengths of a number of input marks that can be preset and wherein an extrapolation module (G) is provided that is used to extrapolate, based on the foregoing, a periodic time length that is to be expected for the next input mark, and whereby the adjustment value for mark generator module (F) is corrected in correction module (K) as a function of the difference between the extrapolated periodic time length and the actual periodic time length of the last mark.

12. Apparatus as claimed in claim 9, wherein query routines are implemented at least in comparison module (E) and extrapolation module (G) that can be used for entering values to which the values fed into correction module (K) are linked.

13. Apparatus as claimed in claim 9, wherein counter module (D) and module (A) for the high-resolution measuring of incoming angle mark signals and mark generator module (F) for the generation of frequency-multiplied angle marks are engineered as part of a circuit in a free programmable Gate Array (FPGA).

14. Apparatus as claimed in claim 9, wherein calculation module (B) for controlling mark generator module (F), counter module (H) for the detected input marks, comparison module (E), correction module (K), buffer module (C) and extrapolation module (G) are engineered as software modules in a signal processor.
